(19) United States
(12) Patent Application Publication
(10) Pub. No.: US 2015/0253913 A1
(43) Pub. Date: Sep. 10, 2015

(54) TOUCH SEPARATION AND TOUCHSCREEN APPARATUS

(71) Applicant: SAMSUNG ELECTRO-MECHANICS CO., LTD., Suwon (KR)

(72) Inventors: Yoon Seok OH, Suwon (KR); Dae Gil YOON, Suwon (KR); Ji Hoon KIM, Suwon (KR); Sang Hyun Sim, Suwon (KR)

(21) Appl. No.: 14/296,845

(22) Filed: Jun. 5, 2014

(30) Foreign Application Priority Data
Mar. 10, 2014 (KR) 10-2014-0027552

(51) Int. Cl. G06F 3/041

(52) U.S. Cl. CPC G06F 3/0412

(57) ABSTRACT

There are provided a touch separation method and a touchscreen apparatus. The touch separation method includes: obtaining a digital signal including a plurality of pieces of digital data depending on changes in capacitances in a plurality of nodes; setting at least one touch group depending on levels of the plurality of pieces of digital data; testing pieces of digital data of the at least one touch group in a preset sequence; and determining a trough depending on a level of a combination of two adjacent pieces of digital data facing each other, based on a test target piece of digital data among the pieces of digital data of the at least one touch group.

### CROSS-REFERENCE TO RELATED APPLICATION

This application claims the benefit of Korean Patent Application No. 10-2014-0027552 filed on Mar. 10, 2014, with the Korean Intellectual Property Office, the disclosure of which is incorporated herein by reference.

### BACKGROUND

The present disclosure relates to a touch separation method and a touchscreen apparatus.

A touchscreen apparatus such as a touchscreen, a touch pad, or the like, a touch interaction apparatus attached to a display apparatus to provide users with an intuitive user interface, has recently been widely used in various electronic devices such as cellular phones, personal digital assistants (PDAs), navigation devices, and the like. Particularly, as demand for smartphones has recently increased, the use of touchscreens as touchscreen apparatuses allowing for the use of various touch interactions in a limited form factor has increased.

Touchscreens used in portable apparatuses may be mainly divided into resistive type touchscreens and capacitive type touchscreens, according to a method of sensing touch interactions utilized thereby. Here, capacitive type touchscreens have advantages in that they have a relatively long lifespan and may easily allow for a range of touch interactions to be used therewith, such that the use thereof has increased. Particularly, capacitive type touchscreens may more easily allow for the implementation of a multi-touch interface as compared to resistive type touchscreens, such that capacitive type touchscreens are widely used in devices such as smartphones, and the like.

Capacitive type touchscreens include a plurality of electrodes having a predetermined pattern and include a plurality of nodes defined by the plurality of electrodes and having changes in capacitance occurring due to touch interactions. In the plurality of nodes distributed on a two-dimensional plane, changes in self-capacitance or changes in mutual-capacitance occur due to touch interactions. Coordinates of touch interactions may be calculated by applying a weighted average method, or the like, to the changes in capacitance occurring in the plurality of nodes.

Recently, multi-touch interactions may be input to touchscreen apparatuses in order to provide user convenience and to allow for the recognition of various gestures. In order to precisely detect all touch interactions within a single multi-touch interaction, an algorithm for separating a single multi-touch group is required.

### RELATED ART DOCUMENT

(Patent Document 1) Korean Patent Laid-Open Publication No. 10-2013-0078462 A

### SUMMARY

An aspect of the present disclosure may provide a touch separation method and a touchscreen apparatus capable of separating a single touch group into at least two touch groups by determining a trough for separating a touch group from levels of digital data set to the touch group.

According to an aspect of the present disclosure, a touch separation method may include: obtaining a digital signal including a plurality of pieces of digital data depending on changes in capacitances in a plurality of nodes; setting at least one touch group depending on levels of the plurality of pieces of digital data; testing pieces of digital data of the at least one touch group in a preset sequence; and determining a trough depending on a level of a combination of two adjacent pieces of digital data facing each other, based on a test target piece of digital data among the pieces of digital data of the at least one touch group.

The at least one touch group may include pieces of digital data having levels equal to a preset reference level or above.

The at least one touch group may include the pieces of digital data having levels equal to the reference level or above, continuously connected to each other and arranged therein.

The touch separation method may further include determining whether or not the pieces of digital data of the at least one touch group have been tested by comparing the number of nodes included in the at least one touch group with a preset value of the number of nodes.

In the determining of whether or not the pieces of digital data of the at least one touch group have been tested, in the case in which the number of nodes included in the at least one touch group is lower than the preset value of the number of nodes, the digital data included in the corresponding touch group may not be detected.

In the determining of whether or not the pieces of digital data of the at least one touch group have been tested, in the case in which the number of nodes included in the at least one touch group is higher than the preset value of the number of nodes, the digital data included in the corresponding touch group may be detected.

The adjacent pieces of digital data may be digital data surrounding the test target piece of digital data.

In the determining of the trough, it may be determined that a node corresponding to the test target piece of digital data is a candidate center trough depending on four combinations each including the two adjacent pieces of digital data facing each other, based on the test target piece of digital data.

In the determining of the trough, it may be decided whether all of digital data of any one of the four combinations are higher than a preset threshold value.

In the determining of the trough, in the case in which all of the pieces of digital data having any one of the four combinations are higher than the threshold value, it may be decided that the node corresponding to the test target piece of digital data is the candidate center trough.

In the determining of the trough, a combination of which a sum is the lowest among the four combinations may be selected, and it may be decided that a node corresponding to the pieces of digital data having the selected combination is a candidate connection trough.

In the determining of the trough, the sum of the pieces of digital data having the selected combination may be compared to a preset operating value to determine that the candidate center trough and the candidate connection trough are a center trough and a connection trough, respectively.

In the determining of the trough, in the case in which the sum of the pieces of digital data having the selected combination is lower than the operating value, it may be determined that the candidate center trough and the candidate connection trough are the center trough and the connection trough, respectively.

The touch separation method may further include comprising changing levels of the pieces of digital data having the trough to a preset data value.

The trough may include a center trough and a connection trough.

The touch separation method may further include deciding whether all of the pieces of digital data having the at least one group have been tested in the case in which a test of a current test target piece of digital data ends.

An algorithm may end in the case in which all of the pieces of digital data having the at least one group are tested.

In the case in which all of the pieces of digital data having the at least one group are not tested, it may be decided whether a node corresponding to a subordinated digital data is a connection trough.

In the case in which the node corresponding to the subordinated digital data is not the connection trough, the subordinated digital data may be tested.

In the case in which the node corresponding to the subordinated digital data is the connection trough, a node corresponding to two pieces of digital data having a lowest level among adjacent pieces of digital data of the subordinated digital data may be selected as a candidate connection trough.

A sum of the pieces of digital data having the candidate connection trough may be compared to a preset operating value to determine that the candidate connection trough is a connection trough.

In the case in which the sum of the pieces of digital data having the candidate connection trough is lower than the operating value, it may be determined that the candidate connection trough is the connection trough.

According to another aspect of the present disclosure, a touchscreen apparatus may include: a signal converting unit converting changes in capacitances in a plurality of nodes into a plurality of pieces of digital data; and an operating unit deciding a touch interaction depending on a digital signal output from the signal converting unit and including the plurality of pieces of digital data, wherein the operating unit sets at least one touch group depending on levels of the plurality of pieces of digital data, tests pieces of digital data of the at least one touch group in a preset sequence, and determines a trough depending on a digital level of a combination of two adjacent pieces of digital data facing each other, based on a test target piece of digital data to separate the at least one touch group.

The at least one touch group may include pieces of digital data having levels equal to a preset reference level or above.

The operating unit may not detect the digital data included in the corresponding touch group in the case in which the number of nodes included in the at least one touch group is lower than a preset value of the number of nodes.

The operating unit may determine that a node corresponding to the test target piece of digital data is a candidate center trough depending on four combinations each including the two adjacent pieces of digital data facing each other, based on the test target piece of digital data.

The operating unit may decide that the node corresponding to the test target piece of digital data is the candidate center trough in the case in which all of the pieces of digital data having any one of the four combinations are higher than a preset threshold value.

The operating unit may select a combination of which a sum is the lowest among the four combinations and decide that a node corresponding to the pieces of digital data having the selected combination is a candidate connection trough.

It may be determined that the candidate center trough and the candidate connection trough are a center trough and a connection trough, respectively, in the case in which the sum of the pieces of digital data having the selected combination is lower than a preset operating value.

The trough may include a center trough and a connection trough, and operating unit may change levels of digital data of a center trough and a connection trough into preset data values.

The trough may include a center trough and a connection trough, and operating unit may decide whether a node corresponding to a subordinated digital data is the connection trough in the case in which a test of a current test target piece of digital data ends and select a node corresponding to two pieces of digital data having a lowest level among adjacent pieces of digital data of the subordinated digital data as a candidate connection trough.

The operating unit may determine that the candidate connection trough is the connection trough in the case in which a sum of the pieces of digital data having the candidate connection trough is lower than a preset operating value.

According to another aspect of the present disclosure, a touchscreen apparatus may include: a signal converting unit converting changes in capacitances in a plurality of nodes into a plurality of pieces of digital data; and an operating unit deciding a touch interaction depending on a digital signal output from the signal converting unit and including the plurality of pieces of digital data, wherein the operating unit sets at least one touch group depending on levels of the plurality of pieces of digital data, compares a digital level of a combination of two adjacent pieces of digital data facing each other, based on a test target piece of digital data among the pieces of digital data of the at least one touch group with a threshold value to separate the at least one touch group, and adjusts the threshold value in a current frame depending on whether or not the at least one touch group has been separated in a previous frame.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view illustrating an appearance of an electronic device including a touchscreen apparatus according to an exemplary embodiment of the present disclosure;

FIG. 2 is a view illustrating a panel unit that may be included in the touchscreen apparatus according to an exemplary embodiment of the present disclosure;

FIG. 3 is a view illustrating a cross section of the panel unit that may be included in the touchscreen apparatus according to an exemplary embodiment of the present disclosure;

FIG. 4 is a view illustrating the touchscreen apparatus according to an exemplary embodiment of the present disclosure;

FIGS. 5 and 6 are flow charts provided for describing a touch separation method according to an exemplary embodiment of the present disclosure;

FIGS. 7 through 10 are views illustrating an example of a digital signal for describing the touch separation method according to an exemplary embodiment of the present disclosure; and

FIG. 11 is a flow chart for describing a threshold value adjusting method according to an exemplary embodiment of the present disclosure.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. In the drawings, the shapes and dimensions of elements may be exaggerated for clarity, and the same reference numerals will be used throughout to designate the same or like elements.

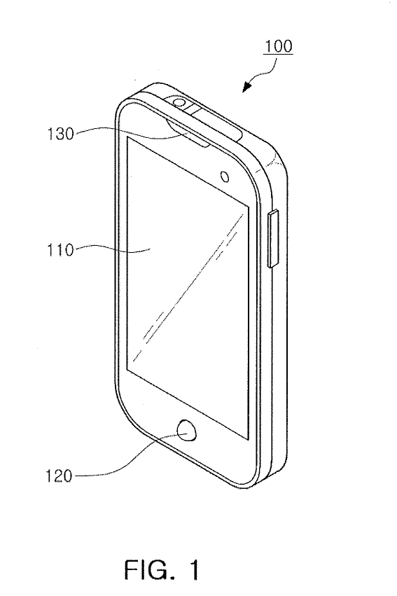

FIG. 1 is a perspective view illustrating an appearance of an electronic device including a touchscreen apparatus according to an exemplary embodiment of the present disclosure.

Referring to FIG. 1, an electronic device 100 according to the present exemplary embodiment may include a display apparatus 110 outputting an image, a touch interaction unit 120, an audio unit 130 outputting an audio, and the like, and may include a touch sensing apparatus integrated with the display apparatus 110.

As shown in FIG. 1, in the case of a mobile device, the touch sensing apparatus may be generally provided in a state in which it is integrated with the display device, and needs to have light transmissivity high enough to transmit a screen displayed by the display apparatus. Therefore, the touch sensing apparatus may be implemented by forming an electrode using a transparent and electrically conductive material such as indium tin oxide (ITO), indium zinc oxide (IZO), zinc oxide (ZnO), carbon nano tube (CNT), or graphene on a base substrate formed of a transparent film material such as polyethylene telephtalate (PET), polycarbonate (PC), polyethersulfone (PES), polyimide (PI), polymethylmechacrylate (PMMA), or the like. In addition, the electrode may be formed using a conductor fine wire formed of any one of Ag, Al, Cr, Ni, Mo, and Cu or an alloy thereof.

The display apparatus may include wiring patterns disposed in a bezel region thereof, wherein the wiring patterns are connected to the electrodes. Since the wiring patterns are visually shielded by the bezel region, they may also be formed of a metal such as silver (Ag), copper (Cu), or the like.

Since it is assumed that the touchscreen apparatus according to an exemplary embodiment of the present disclosure is operated in a capacitive scheme, the touchscreen apparatus may include a plurality of electrodes having a predetermined pattern. In addition, the touchscreen apparatus according to an exemplary embodiment of the present disclosure may include a capacitance sensing circuit detecting changes in capacitances occurring in the plurality of electrodes, an analog-to-digital converting circuit converting an output signal of the capacitance sensing circuit into a digital value, and an operating circuit deciding a touch interaction using a data converted into the digital value, and the like.

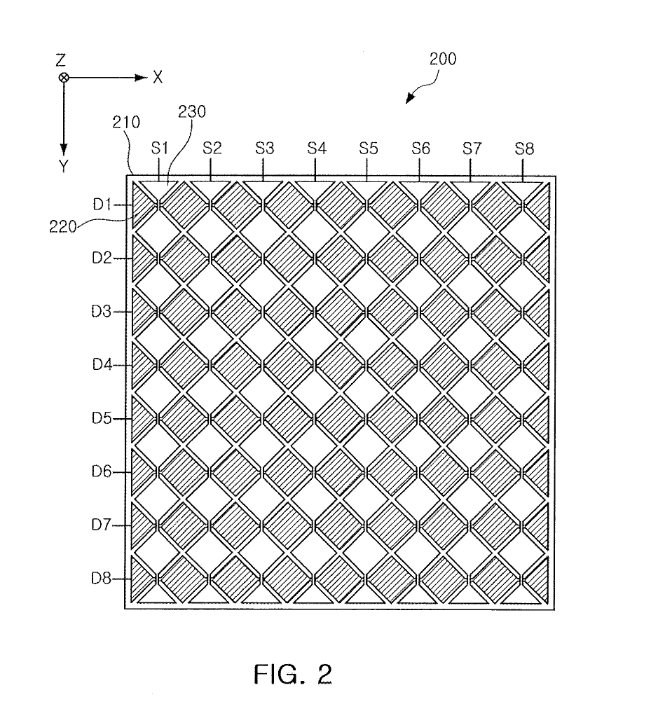

FIG. 2 is a view illustrating a panel unit that may be included in the touchscreen apparatus according to an exemplary embodiment of the present disclosure.

Referring to FIG. 2, a panel unit 200 according to the present exemplary embodiment may include a substrate 210 and a plurality of electrodes 220 and 230 provided on the substrate 210. Although not shown in FIG. 2, each of the plurality of electrodes 220 and 230 may be electrically connected to a wiring pattern of a circuit board attached to one end of the substrate 210 through a wiring and a bonding pad. A controller integrated circuit (controlling unit) may be mounted on the circuit board to detect sensing signals generated in the plurality of electrodes 220 and 230 and decide a touch interaction from the sensing signals.

The plurality of electrodes 220 and 230 may be provided on one surface or both surfaces of the substrate 210. Although the case in which the plurality of electrodes 220 and 230 have patterns having a rhombus or diamond shape has been shown in FIG. 2, the plurality of electrodes 220 and 230 may have patterns having various polygonal shapes such as a rectangular shape, a triangular shape, and the like.

The plurality of electrodes 220 and 230 may include first electrodes 220 extended in an X axis direction and second electrodes 230 extended in a Y axis. The first electrodes 220 and the second electrodes 230 may be provided on both surfaces of the substrate 210 or be provided on different substrates 210 and intersect with each other. In the case in which both of the first and second electrodes 220 and 230 are provided on one surface of the substrate 210, predetermined insulating layers may be partially formed in intersection points therebetween.

In addition, a predetermined printed region for visually shielding wirings generally formed of a non-transparent metal may be formed in a region in which the wirings connected to the plurality of electrodes 220 and 230 are formed, other than a region in which the plurality of electrodes 220 and 230 are formed, on the substrate 210.

An apparatus electrically connected to the plurality of electrodes 220 and 230 to sense the touch interaction may detect changes in capacitances occurring in the plurality of electrodes 220 and 230 by a touch interaction and sense the touch interaction from the changes in the capacitances. The first electrodes 220 may be connected to channels defined as D1 to D8 in the controller integrated circuit to thereby receive predetermined driving signals applied thereto, and the second electrodes 230 may be connected to channels defined as S1 to S8 in the controller integrated circuit to thereby be used for the touch sensing apparatus to detect a sensing signal. Here, the controller integrated circuit may detect a change in a mutual-capacitance occurring between the first and second electrodes 220 and 230 as the sensing signal.

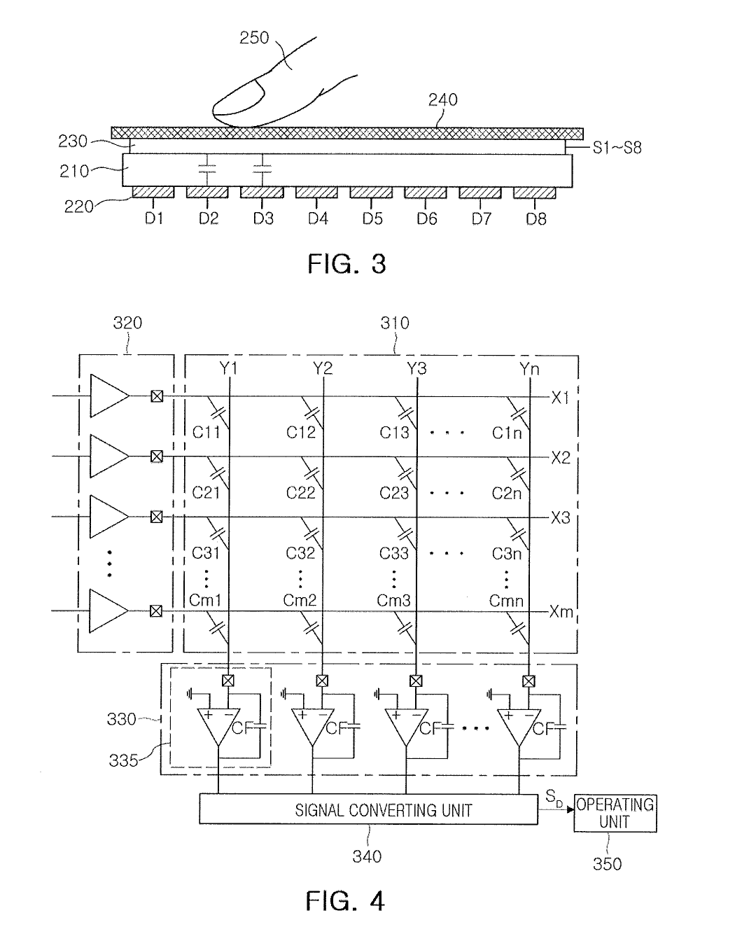

FIG. 3 is a view illustrating a cross section of the panel unit that may be included in the touchscreen apparatus according to an exemplary embodiment of the present disclosure. FIG. 3 is a cross-sectional view of the panel part 200 of FIG. 2 taken along a Y-Z plane. The panel unit 200 may further include a cover lens 240 receiving a touch applied thereto, in addition to the substrate 210 and the plurality of sensing electrodes 220 and 230 described with reference to FIG. 2. The cover lens 240 may be provided on the second electrode 230 used to detect the sensing signal and may receive a touch interaction applied from a touch object 250, such as a finger, or the like, thereto.

When a driving signal is applied to the first electrode 220 through the channels D1 to D8, a mutual-capacitance may be generated between the first electrode 220 to which the driving signal is applied and the second electrode 230. When the touch object 250 touches the cover lens 240, a change may occur in the mutual-capacitance generated between the first and second electrodes 220 and 230 adjacent to a region touched by the touch object 250. The change in the capacitance may be in proportion to an area of an overlapped region between the touch object 250 and the first electrode 220 having the driving signal applied thereto and the second electrode 230. In FIG. 3, mutual-capacitances generated between the first and second electrodes 220 and 230 connected to the channels D2 and D3, respectively, may be affected by the touch object 250.

FIG. 4 is a view illustrating the touchscreen apparatus according to an exemplary embodiment of the present disclosure.

Referring to FIG. 4, the touchscreen apparatus according to the present exemplary embodiment may include a panel unit 310, a driving circuit unit 320, a sensing circuit unit 330, a signal converting unit 340, and an operating unit 350. Here, the driving circuit unit 320, the sensing circuit unit 330, the signal converting unit 340, and the operating unit 350 may be implemented as a single integrated circuit (IC).

The panel unit 310 may include a plurality of first electrodes (driving electrodes) X1 to Xm extended in a first axis direction (that is, a horizontal direction of FIG. 4) and disposed in a plurality of rows and a plurality of second electrodes (sensing electrodes) Y1 to Yn extended in a second axis direction (that is, a vertical direction of FIG. 4) intersecting with the first axis and disposed in a plurality of columns. As described above, capacitances may be generated in intersection points between the plurality of first electrodes X1 to Xm and the plurality of second electrodes Y1 to Yn. Node capacitors C11 to Cmn shown in FIG. 4 indicate capacitances generated at the intersection points between the plurality of first electrodes X1 to Xm and the plurality of second electrodes Y1 to Yn and shown as capacitor components.

The driving circuit unit 320 may apply predetermined driving signals to the plurality of first electrodes X1 to Xm of the panel unit 310. The driving signals may be square wave signals, sine wave signals, triangle wave signals, or the like, having a predetermined period and amplitude and may be sequentially applied to each of the plurality of first electrodes X1 to Xm. Although the case in which circuits for generating and applying the driving signals are individually connected to the plurality of first electrodes X1 to Xm, respectively, is shown in FIG. 4, a single driving signal generating circuit may generate driving signals and apply the generated driving signals to the plurality of first electrodes X1 to Xm, respectively, using a switching circuit. In addition, the driving circuit unit may be operated in a scheme in which it simultaneously applies the driving signals to all of the first electrodes or selectively applies the driving signals to only some of the first electrodes to simply sense whether or not the touch interaction is present.

The sensing circuit unit 330 may detect the capacitances of the node capacitors C11 to Cmn from the plurality of second electrodes Y1 to Yn. The sensing circuit unit 330 may include a plurality of C-V converters 335 each including at least one operational amplifier and at least one capacitor and each connected to the plurality of second electrodes Y1 and Yn.

The plurality of C-V converters 335 may convert the capacitances of the node capacitors C11 to Cmn into voltage signals, respectively, to output analog signals. As an example, each of the plurality of C-V converters 335 may include an integration circuit integrating a capacitance. The integration circuit may integrate the capacitance to change the capacitance into a predetermined voltage and output the predetermined voltage.

Although a configuration of the C-V converter 335 in which the capacitor CF is disposed between an inverting terminal and an output terminal of the operational amplifier has been shown in FIG. 4, the configuration of the C-V converter 335 may be changed. Further, although the case in which the C-V converter 335 includes one operational amplifier and one capacitor has been shown in FIG. 4, the C-V converter 335 may include a plurality of operational amplifiers and a plurality of capacitors.

Since the capacitances may be simultaneously detected from the plurality of second electrodes in the case in which the driving signals are sequentially applied to the plurality of first electrodes X1 to Xm, the number of C-V converters 335 may correspond to n, which is the number of second electrodes Y1 and Yn.

The signal converting unit 340 may generate a digital signal S_{D} from the analog signal output from the sensing circuit unit 330. For example, the signal converting unit 340 may include a time-to-digital converter (TDC) circuit measuring a time in which the analog signal output in a voltage form from the sensing circuit unit 330 arrives at a predetermined reference voltage level and converting the measured time into the digital signal S_{D} or an analog-to-digital converter (ADC) circuit measuring an amount by which a level of the analog signal output from the sensing circuit unit 330 is changed for a predetermined time and converting the change amount into the digital signal S_{D}.

The operating unit 350 may decide a touch interaction applied to the panel unit 310 using the digital signal S_{D}. The operating unit 350 may decide the number, coordinates, gesture operations, or the like, of touch interactions applied to the panel unit 310 using the digital signal S_{D}.

The digital signal S_{D}, the basis on which the operating unit 350 decides the touch interaction, may be data generated by digitizing the changes in the capacitances in the node capacitors C11 to Cmn and may be data indicating a difference between capacitances particularly in the case in which the touch interaction does not occur and in the case in which the touch interaction occurs. Usually, in a capacitive type touchscreen apparatus, since a capacitance is decreased in a region that is touched by a conductive object than in a region in which the touch does not occur, a change in the capacitance in the region that is touched by the conductive object may be higher than a change in the capacitance in the region in which the touch does not occur.

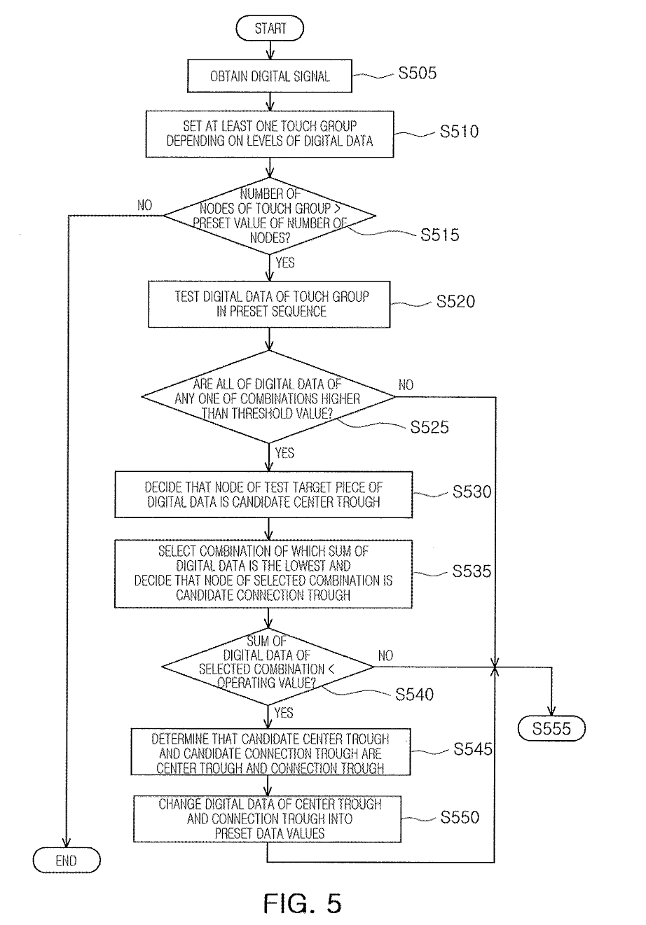

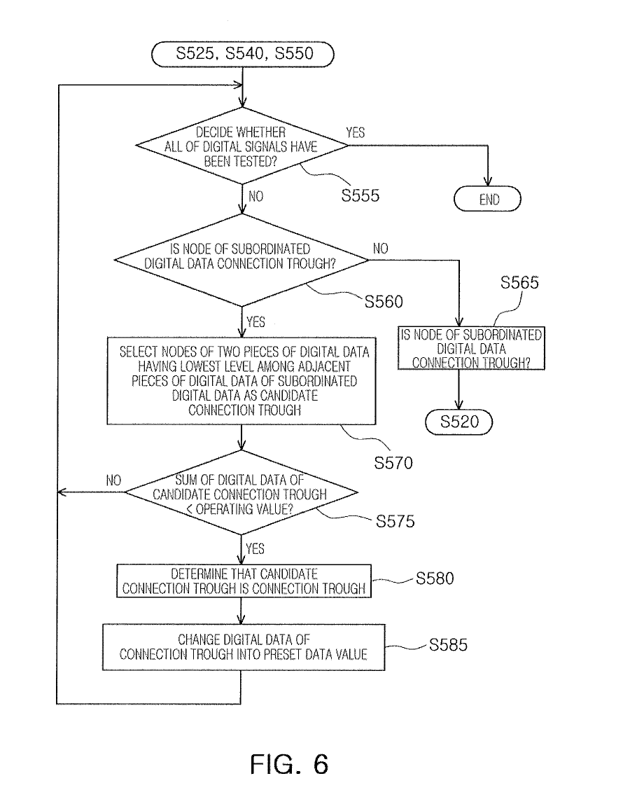

FIGS. 5 and 6 are flow charts provided for describing a touch separation method according to an exemplary embodiment of the present disclosure. Hereinafter, a touch separation method according to the present exemplary embodiment will be described in detail with reference to FIGS. 4 through 6.

Referring to FIG. 5, in the touch separation method according to the present exemplary embodiment, the operating unit 350 may first obtain the digital signal (S505). In order to obtain the digital signal, the driving circuit unit 320 may apply the driving signals to the plurality of first electrodes, and the sensing circuit unit 330 may detect the capacitances from the plurality of second electrodes intersecting with the first electrodes to which the driving signals are applied. The sensing circuit unit 330 may detect the changes in the capacitances in the analog signal form using the integration circuit, and the analog signal output from the sensing circuit unit 330 may be converted into the digital signal S_{D} by the signal converting unit 340. The operating unit 350 may separate the touch interaction using the digital signal S_{D} and decide the number, coordinates, gesture operations, or the like, of touch interactions from the separated touch interaction.

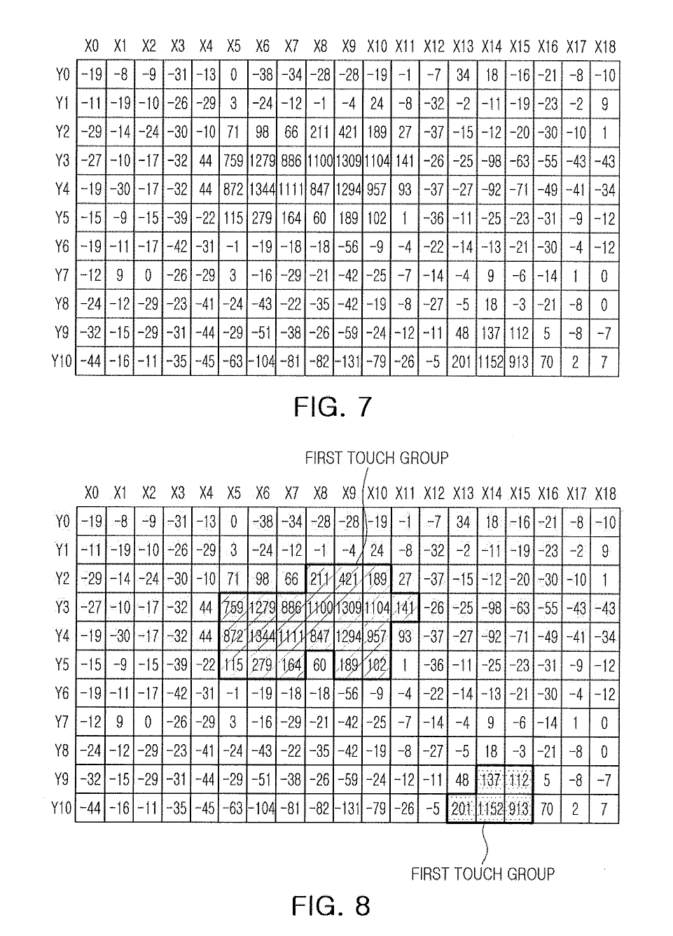

FIG. 7 shows an example of a digital signal. In the case in which it is assumed that the number of first electrodes X1 to Xm and the number of second electrodes Y1 to Yn in FIG. 4 are 18 and 10, respectively, the digital signal may include a plurality of pieces of digital data depending on the changes in the capacitances in the respective nodes in which the plurality of first electrodes X1 to X18 and the plurality of second electrodes Y1 to Y10 intersect with each other.

The operating unit 350 may set at least one touch group depending on levels of the digital data (S510). The touch group may mean a group initially recognized as a single touch interaction. The touch group may include pieces of digital data having levels equal to a preset reference level or above. That is, the pieces of digital data having the preset reference level or above may be continuously connected to each other and arranged in one touch group. Here, the reference level may be a value set in order to distinguish an effective touch and noise from each other.

As an example, in the case in which the reference level for setting the touch group is set to 100, first and second touch groups may be set as shown in FIG. 8.

The operating unit 350 may compare the number of nodes included in the set touch group with a preset value of the number of nodes (S515). The operating unit 350 may compare the number of nodes corresponding to the touch group with the preset value of the number of nodes, and decide that the touch group is sufficiently small to end an algorithm, in the case in which the preset value of the number of nodes is higher than that of nodes corresponding to the touch group. However, the operating unit 350 may decide that the touch group is large enough to be separated to test digital data included in the touch group, in the case in which the number of nodes of the touch group is higher than the preset value of the number of nodes. Here, the number of nodes of the touch group compared by the operating unit 350 may be at least one of the number of nodes included in all touch groups and the number of nodes defining the shortest distance, the longest distance, a width, and a height of the touch group.

As an example, when it is assumed that the preset value of the number of nodes is 10 and the operating unit 350 compares the number of nodes included in all touch groups with the preset value of the number of nodes, the operating unit 350 may decide that the second touch group is a single touch to end the algorithm, since 5, which is the number of nodes of the second touch group of FIG. 8, is lower than 10, which is preset value of the number of nodes and may test the respective digital data of the first touch group in order to separate the first touch group, since 21, which is the number of nodes of the first touch group of FIG. 8, is higher than 10, which is preset value of the number of nodes.

The operating unit 350 may test all digital data in the touch group in a preset sequence (S520) and may determine a trough depending on levels of adjacent pieces of digital data of a test target piece of digital data. Here, the trough may include a center trough and a connection trough, and the operating unit 350 may detect the trough rather than finding a peak value within the touch group and separate the touch group depending on the trough.

The adjacent pieces of digital data may be digital data surrounding the test target piece of digital data. For example, in the case in which a digital data of a node (X7, Y3) of FIG. 8 is the test target piece of digital data, the adjacent pieces of digital data may be digital data of eight nodes surrounding the node (X7, Y3).

In the case in which two adjacent pieces of digital data facing each other, based on the test target piece of digital data are defined as one combination, the operating unit 350 may compare digital levels of the respective combinations with a preset threshold value to decide whether all of digital data of any one of the combinations are higher than the threshold value (S525).

The threshold value may include first and second threshold values (first threshold value>second threshold value). In this case, the operating unit 350 may decide whether any one of the digital data is higher than the second threshold value and are higher than the first threshold value.

Here, the adjacent pieces of digital data facing each other may indicate digital data of nodes disposed symmetrically to each other (in a horizontal direction, a vertical direction, or a diagonal direction) based on a node of the test target piece of digital data. In the case in which a node (X7, Y3) of FIG.

7 is a test target, the operating unit 350 may compare digital data of a first combination of nodes (X6, Y2) and (X8, Y4), a second combination of nodes (X7, Y2) and (X7, Y4), a third combination of nodes (X8, Y2) and (X6, Y4), and a fourth combination of nodes (X6, Y3) and (X8, Y3) with the threshold value.

As a comparison result, in the case in which any one of the pieces of digital data having all of the combinations is lower than the threshold value, it may be decided that a node corresponding to the test target piece of digital data is not a candidate center trough. In the case in which it is not decided that the test target piece of digital data is not the candidate center trough, the operating unit 350 may execute S555 in order to test a subordinated digital data, which will be described in detail later.

As a comparison result, in the case in which all of the pieces of digital data having any one of the combinations is higher than the threshold value, the operating unit 350 may decide that a node corresponding to the test target piece of digital data is the candidate center trough (S530).

As an example, in the case in which the threshold value is set to 1000, since both of 1279 and 1100, which are the pieces of digital data having the fourth combination of FIG. 8, are higher than 1000, which is the threshold value, the operating unit 350 may decide that the node (X7, Y3) corresponding to the test target piece of digital data 886 is the candidate center trough.

In the case in which the candidate center trough is determined, the operating unit 350 may select a combination of which the sum of the digital data is the lowest and decide that a node corresponding to the selected combination is a candidate connection trough (S535). Then, the operating unit 350 may compare the sum of the pieces of digital data having the selected combination with a preset operating value (S540). In the case in which the sum of the pieces of digital data having the selected combination is higher than the preset operating value, S555 may be executed, and in the case in which the sum of the pieces of digital data having the selected combination is lower than the preset operating value, it may be determined that the candidate center trough and the candidate connection trough are a center trough and a connection trough, respectively (S545).

In an example of FIG. 8 described above, the combination of which the sum of the digital data is the lowest may be the first combination of the nodes (X6, Y2) and (X8, Y4). Since the sum of the pieces of digital data having the first combination is 945, which is lower than 1000 corresponding to the set threshold value, the operating unit 350 may determine that the candidate center trough and the candidate connection trough are the center trough and the connection trough, respectively.

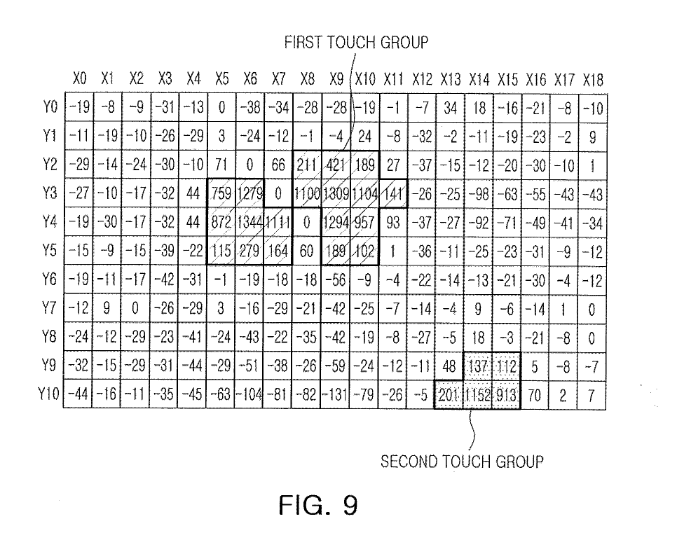

The operating unit 350 may change digital data of the center trough and the connection trough into preset data values (S550) in the case in which the center trough and the connection trough are determined. For example, in the case in which a preset data value is 0, a digital signal as shown in FIG. 8 may be changed into a digital signal as shown in FIG. 9.

Then, the operating unit 350 may decide whether all of the digital data have been tested in order to test the subordinated digital data (S555) and may end a touch separation algorithm in the case in which all of the digital data are tested.

In the case in which all of the digital data are not tested, the operating unit 350 may decide whether a node of the subordinated digital data is the connection trough (S560), and may test the subordinated digital data in a scheme similar to the scheme described above (S565) in the case in which the node of the subordinated digital data is not the connection trough.

However, in the case in which the node of the subordinated digital data is the connection trough, the operating unit 350 may select nodes of two pieces of digital data having the lowest level among adjacent pieces of digital data of the connection trough as a candidate connection trough (S570). For example, in FIG. 9, in the case in which the node (X8, Y4), which is the subordinated digital data, is a test target, since the node (X8, Y4) is the connection trough, the operating unit 350 may select the nodes (X7, Y3) and (X8, Y5) corresponding to 0 and 60, which are two pieces of digital data having the lowest level among adjacent pieces of digital data of the connection trough, as the candidate connection valley.

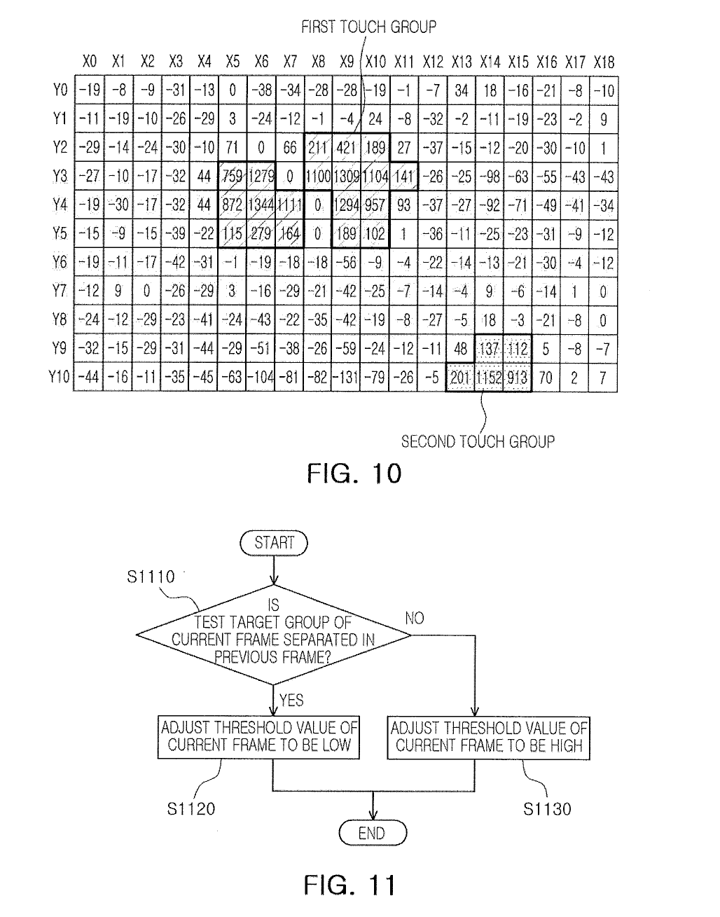

Then, the operating unit 350 may compare the sum of the pieces of digital data having the candidate connection trough with a preset operating value in a scheme similar to the scheme described above (S575). As a comparison result, in the case in which the sum of the pieces of digital data having the candidate connection trough is higher than the operating value, the operating unit 350 may execute S555. Unlike this, in the case in which the sum of the pieces of digital data having the candidate connection trough is lower than the operating value, the operating unit 350 may determine that the candidate connection trough is a connection trough (S580) and then change digital data of the connection trough to a preset data value (S585). For example, in FIG. 9, since the sum of the pieces of digital data having the nodes (X7, Y3) and (X8, Y5) is 60, which is lower than 1000 corresponding to the preset operating value, it may be determined that the nodes (X7, Y3) and (X8, Y5) are the connection trough, and a digital signal as shown in FIG. 9 may be changed into a digital signal as shown in FIG. 10 in the case in which the pieces of digital data having the determined connection trough is changed into 0, which is the preset data value (S585). Then, the operating unit 350 may execute S555 in order to test a subordinated digital data of a current test target piece of digital data.

Referring to FIG. 10, it may be confirmed that the first touch group may be separated into two groups, and the operating unit 350 may precisely decide the number, coordinates, gesture operations, or the like, of touch interactions depending on the separated touch groups.

FIG. 11 is a flowchart for describing a threshold value adjusting method according to an exemplary embodiment of the present disclosure.

The operating unit 350 may obtain a plurality of pieces of digital data depending on the changes in the capacitances in all of intersection nodes between the plurality of first electrodes and the plurality of second electrodes in one frame once, thereby sequentially sensing a series of touch interactions depending on continuous frames. The touches interaction by a user may have predetermined directionality. Therefore, according to the present exemplary embodiment, a threshold value in a current frame may be adjusted so that a state of a touch group in a previous frame is maintained.

The operating unit 350 may decide whether a test target touch group of a current frame has been separated in a previous frame (S1110). In the case in which the test target touch group of the current frame is separated into at least two groups in the previous frame, the operating unit 350 may set a preset threshold value of the current frame to be lower than that of the previous frame (S1120). However, in the case in which the test target touch group of the current frame is maintained as one touch group in the previous frame, the operating unit 350 may set a preset threshold value of the current frame to be higher than that of the previous frame (S1130).

As set forth above, according to exemplary embodiments of the present disclosure, a trough portion is detected without detecting a peak point in a touch group, whereby one touch group may be separated into two touch groups in a simple scheme.

While exemplary embodiments have been shown and described above, it will be apparent to those skilled in the art that modifications and variations could be made without departing from the spirit and scope of the present disclosure as defined by the appended claims.

What is claimed is:

1. A touch separation method comprising:
obtaining a digital signal including a plurality of pieces of digital data depending on changes in capacitances in a plurality of nodes;
setting at least one touch group depending on levels of the plurality of pieces of digital data;
testing pieces of digital data of the at least one touch group in a preset sequence; and
determining a trough depending on a level of a combination of two adjacent pieces of digital data facing each other, based on a test target piece of digital data among the pieces of digital data of the at least one touch group.

2. The touch separation method of claim 1, wherein the at least one touch group includes pieces of digital data having levels equal to a preset reference level or above.

3. The touch separation method of claim 2, wherein the at least one touch group includes the pieces of digital data having levels equal to the reference level or above, continuously connected to each other and arranged therein.

4. The touch separation method of claim 1, further comprising determining whether or not the pieces of digital data of the at least one touch group have been tested by comparing the number of nodes included in the at least one touch group with a preset value of the number of nodes.

5. The touch separation method of claim 4, wherein in the determining of whether or not the pieces of digital data of the at least one touch group have been tested, in the case in which the number of nodes included in the at least one touch group is lower than the preset value of the number of nodes, the digital data included in the corresponding touch group are not detected.

6. The touch separation method of claim 4, wherein in the determining of whether or not the pieces of digital data of the at least one touch group have been tested, in the case in which the number of nodes included in the at least one touch group is higher than the preset value of the number of nodes, the digital data included in the corresponding touch group are detected.

7. The touch separation method of claim 1, wherein the adjacent pieces of digital data are digital data surrounding the test target piece of digital data.

8. The touch separation method of claim 1, wherein in the determining of the trough, it is determined that a node corresponding to the test target piece of digital data is a candidate center trough depending on four combinations each including the two adjacent pieces of digital data facing each other, based on the test target piece of digital data.

9. The touch separation method of claim 8, wherein in the determining of the trough, it is decided whether all of digital data of any one of the four combinations are higher than a preset threshold value.

10. The touch separation method of claim 9, wherein in the determining of the trough, in the case in which all of the pieces of digital data having any one of the four combinations are higher than the threshold value, it is decided that the node corresponding to the test target piece of digital data is the candidate center trough.

11. The touch separation method of claim 9, wherein in the determining of the trough, a combination of which a sum is the lowest among the four combinations is selected, and it is decided that a node corresponding to the pieces of digital data having the selected combination is a candidate connection trough.

12. The touch separation method of claim 11, wherein in the determining of the trough, the sum of the pieces of digital data having the selected combination is compared to a preset operating value to determine that the candidate center trough and the candidate connection trough are a center trough and a connection trough, respectively.

13. The touch separation method of claim 12, wherein in the determining of the trough, in the case in which the sum of the pieces of digital data having the selected combination is lower than the operating value, it is determined that the candidate center trough and the candidate connection trough are the center trough and the connection trough, respectively.

14. The touch separation method of claim 1, further comprising changing levels of the pieces of digital data having the trough to a preset data value.

15. The touch separation method of claim 14, wherein the trough includes a center trough and a connection trough.

16. The touch separation method of claim 1, further comprising deciding whether all of the pieces of digital data having the at least one group have been tested in the case in which a test of a current test target piece of digital data ends.

17. The touch separation method of claim 16, wherein an algorithm ends in the case in which all of the pieces of digital data having the at least one group are tested.

18. The touch separation method of claim 16, wherein in the case in which all of the pieces of digital data having the at least one group are not tested, it is decided whether a node corresponding to a subordinated digital data is a connection trough.

19. The touch separation method of claim 18, wherein in the case in which the node corresponding to the subordinated digital data is not the connection trough, the subordinated digital data is tested.

20. The touch separation method of claim 18, wherein in the case in which the node corresponding to the subordinated digital data is the connection trough, a node corresponding to two pieces of digital data having a lowest level among adjacent pieces of digital data of the subordinated digital data is selected as a candidate connection trough.

21. The touch separation method of claim 20, wherein a sum of the pieces of digital data having the candidate connection trough is compared to a preset operating value to determine that the candidate connection trough is a connection trough.

22. The touch separation method of claim 21, wherein in the case in which the sum of the pieces of digital data having the candidate connection trough is lower than the operating value, it is determined that the candidate connection trough is the connection trough.

23. A touchscreen apparatus comprising:
a signal converting unit converting changes in capacitances in a plurality of nodes into a plurality of pieces of digital data; and
an operating unit deciding a touch interaction depending on a digital signal output from the signal converting unit and including the plurality of pieces of digital data,
wherein the operating unit sets at least one touch group depending on levels of the plurality of pieces of digital data, tests pieces of digital data of the at least one touch group in a preset sequence, and determines a trough depending on a digital level of a combination of two adjacent pieces of digital data facing each other, based on a test target piece of digital data to separate the at least one touch group.

24. The touchscreen apparatus of claim 23, wherein the at least one touch group includes pieces of digital data having levels equal to a preset reference level or above.

25. The touchscreen apparatus of claim 23, wherein the operating unit does not detect the digital data included in the corresponding touch group in the case in which the number of nodes included in the at least one touch group is lower than a preset value of the number of nodes.

26. The touchscreen apparatus of claim 23, wherein the operating unit determines that anode corresponding to the test target piece of digital data is a candidate center trough depending on four combinations each including the two adjacent pieces of digital data facing each other, based on the test target piece of digital data.

27. The touchscreen apparatus of claim 26, wherein the operating unit decides that the node corresponding to the test target piece of digital data is the candidate center trough in the case in which all of the pieces of digital data having any one of the four combinations are higher than a preset threshold value.

28. The touchscreen apparatus of claim 27, wherein the operating unit selects a combination of which a sum is the lowest among the four combinations and decides that a node corresponding to the pieces of digital data having the selected combination is a candidate connection trough.

29. The touchscreen apparatus of claim 28, wherein it is determined that the candidate center trough and the candidate connection trough are a center trough and a connection trough, respectively, in the case in which the sum of the pieces of digital data having the selected combination is lower than a preset operating value.

30. The touchscreen apparatus of claim 23, wherein the trough includes a center trough and a connection trough, and operating unit changes levels of digital data of a center trough and a connection trough into preset data values.

31. The touchscreen apparatus of claim 23, wherein the trough includes a center trough and a connection trough, and operating unit decides whether a node corresponding to a subordinated digital data is the connection trough in the case in which a test of a current test target piece of digital data ends and selects a node corresponding to two pieces of digital data having a lowest level among adjacent pieces of digital data of the subordinated digital data as a candidate connection trough.

32. The touchscreen apparatus of claim 31, wherein the operating unit determines that the candidate connection trough is the connection trough in the case in which a sum of the pieces of digital data having the candidate connection trough is lower than a preset operating value.

33. A touchscreen apparatus comprising:
a signal converting unit converting changes in capacitances in a plurality of nodes into a plurality of pieces of digital data; and
an operating unit deciding a touch interaction depending on a digital signal output from the signal converting unit and including the plurality of pieces of digital data,
wherein the operating unit sets at least one touch group depending on levels of the plurality of pieces of digital data, compares a digital level of a combination of two adjacent pieces of digital data facing each other, based on a test target piece of digital data among the pieces of digital data of the at least one touch group with a threshold value to separate the at least one touch group, and adjusts the threshold value in a current frame depending on whether or not the at least one touch group has been separated in a previous frame.
